(19) United States
(12) Patent Application Publication
(10) Pub. No.: US 2006/0253368 A1
(43) Pub. Date: Nov. 9, 2006

(54) System and method for creating and trading credit rating derivative investment instruments

(75) Inventors: Dennis M. O'Callahan, Evanston, IL (US); Dominic J. Salvino, Naperville, IL (US); Catherine T. Shalen, Chicago, IL (US)

Correspondence Address: BRINKS HOFER GILSON & LIONE, P.O. BOX 10395, CHICAGO, IL, 60610, US

(73) Assignee: Chicago Board Options Exchange

(21) Appl. No.: 11/122,510

(22) Filed: May 4, 2005

(51) Int. Cl. G06Q 40/00

(52) U.S. Cl. 705/37

(57) ABSTRACT

A method of creating and trading packaged standard credit rating derivatives on an exchange is provided, as well as a trading facility for trading such packaged standard credit rating derivatives. Credit rating derivatives are created by identifying a credit rating service that includes a plurality of risk categories. Unique monetary values are mapped to risk categories and an entity rated by the credit rating service is identified. A credit rating derivative is then created whose value is determined at least in part by the monetary value to which the risk category associated with the rated entity is mapped.

### FIELD OF THE INVENTION

The present invention relates to methods and systems for creating and trading credit rating derivative investment instruments based on the credit ratings of various organizations.

### BACKGROUND

Lending money involves risk. Regardless of who the borrower is, be it an individual, corporation, municipality, national government, or supranational organization such as the World Bank or the United Nations, there is always a possibility of default. In many cases the risk of default is very, very remote. In others it is less so. Interest rates on loans are determined based on, among other things, a borrower's perceived ability to repay the loan. Paradoxically, a borrower whose ability to repay a loan is less certain will have pay more to borrow money in the form of higher interest rates than a borrower who is perceived to be less of a risk. Because debt plays a vital role in the world's economy, assessing risk is of critical importance to ensuring the desired flow capital from those who have it to those who would use it.

Over time, credit rating services have developed to assist lenders and investors in assessing risk and evaluating the overall credit worthiness of individuals and organizations. These credit rating services produce credit ratings for individuals and organizations that reflect the rated party's ability to repay its debts. Investors and lenders rely on such ratings when deciding whether to extend financing, and on what terms. In the United States, three major credit rating services are Moody's Investor Services (Moody's), Standard and Poor's (S & P), and Fitch's Ratings (Fitch's).

The rating schemes followed by the three major rating services are all similar. Each includes multiple levels, with each level representing a different level of risk, or a different ranking of the perceived ability of a rated entity to meet its debt obligations. Each of the different levels is identified by a 1 to 3 letter code. For example Moody's defines nine primary risk levels:

Aaa, Aa, A, Baa, Ba, B, Caa, Ca, and C.

According to this system, the Aaa rating is reserved for the entities that demonstrate the strongest credit worthiness. Debt issuers or debt issues rated Aa demonstrate very strong credit worthiness but somewhat less than those rated Aaa, while rated simply those A represent above average credit worthiness. Issuers or issues rated Baa represent average credit worthiness. Those rated Ba demonstrate below average credit worthiness, and those rated B demonstrate weak credit worthiness. Finally, issuers or issues rated Caa demonstrate very weak credit worthiness. Those rated Ca demonstrate extremely weak credit worthiness, and those rated C demonstrate the weakest credit. Moody's also appends a numeric modifier 1, 2 or 3 to the categories Aa through Caa. The numeric modifiers indicate where within the particular risk category the entity being evaluated falls. 1 indicates the top rating within the group. 2 indicates the middle of the group. 3 represents the bottom. The modifiers 1, 2, 3 effectively expand the number of risk categories to a total of twenty-one.

S&P's alphabetic rating system is similar to Moody's. S&P defines its primary risk categories as:

AAA, AA, A, BBB, BB, B, CCC, CC, C, and D.

The definitions of S&P's categories roughly track those of Moody's and need not be explicitly related here. S&P append a (+) or (−) to categories AA to CCC in order to show an entity's relative standing within the major rating categories. With the modifiers, S&P's rating system effectively includes 16 different levels of risk.

Fitch also relies on a letter rating code similar to those already described:

AAA, AA, A, BBB, BB, B, CCC, CC, C, DDD, DD, and D.

Fitch also includes a (+) or (−) modifier to categories AA-CCC to indicate an entities relative position within a category. Thus, Fitch ratings may take on up to 18 different the levels.

The rating services monitor the financial health of the organizations they rate, updating their ratings as conditions warrant. If the rating services perceive a change in an organizations ability to meet its obligations the rating service may downgrade its rating of the organization. In contrast, improved financial circumstances may cause the rating services to upgrade an entity's credit rating. Thus, much like a company's stock price an entity's credit rating may serve as a barometer of the entity's financial health. During good times the credit rating will go up. In the bad times it will likely go down.

Derivatives are financial securities whose values are derived in part from a value or characteristic of some other underlying asset or variable (the underlying asset). The underlying asset may include securities such as stocks, commodities market indicators and indexes, and interest rate to name but a few. Two common forms of derivatives are options contracts and futures contracts.

An option is a contract giving the holder of the option the right, but not the obligation, to buy or sell an underlying asset at a specific price on or before a certain date. Generally, a party who purchases an option is said to have taken a long position with respect to the option. The party who sells the option is said to have taken a short position. There are generally two types of options: calls and puts. An investor who has taken a long position in a call option has bought the right to purchase the underlying asset at a specific price, known as the “strike price.” If the long investor chooses to exercise the call option, the long investor pays the strike price to the short investor, and the short investor is obligated to deliver the underlying asset.

Alternatively, an investor who has taken a long position in a put option receives the right, but not the obligation to sell the underlying asset at a specified price, again referred to as the strike price on or before a specified date. If the long investor chooses to exercises the put option, the short investor is obligated to purchase the underlying asset from the long investor at the agreed upon strike price. The long investor must then deliver the underlying asset to the short investor. Thus, the traditional settlement process for option contracts involves the transfer of funds from the purchaser of the underlying asset to the seller, and the transfer of the underlying asset from the seller of the underlying asset to the purchaser. Cash settlement, however, is more common. Cash settlement allows options contracts to be settled without actually transferring the underlying asset. A call option is “in-the-money” when the price or value of the underlying asset rises above the strike price of the option. A put option is “in-the-money” when the price or value of the underlying asset falls below the strike price of the option. An at-the-money option wherein the price or value of the underlying asset is equal to the strike price of the option. A call option is out-of-the-money when the price or value of the underlying asset is below the strike price. An A put option is out-of-the-money when the price or value of the underlying asset is above the strike price. If an option expires at-the-money or out-of-the-money, it has no value. The short investor retains the amount paid by the long investor (the option price) and pays nothing to the long investor. Cash settlement of an in-the-money option, be it a call or a put, however, requires the short investor to pay to the long investor the difference between the strike price and the current market value of the underlying asset.

Cash settlement allows options to be based on more abstract underlying “assets” such as market indicators, stock indices, interest rates, futures contracts and other derivatives. For example, an investor may take a long position in a market index call option. In this case, the long investor receives the right to “purchase” not the index itself, but rather a cash amount equal to the value of the index (typically multiplied by a multiplier) at a specified strike value. An index call option is in-the-money when the value of the index rises above the strike value. When the holder of an in-the-money index call option exercises the option, the short investor on the opposite side of the contract is obligated to pay the long investor the difference between the current value of the index and the strike price, usually multiplied by the multiplier. If the current value of the index is less than or equal to the strike value, the option has no value. An index put option works in the same way but in reverse, having value, or being in-the-money when the value of the index falls below the strike value.

Futures contracts are another common derivative security. In a futures contract a buyer purchases the right to receive delivery of an underlying commodity or asset on a specified date in the future. Conversely, a seller agrees to deliver the commodity or asset to an agreed location on the specified date. Futures contracts originally developed in the trade of agricultural commodities, but quickly spread to other commodities as well. Because futures contracts establish a price for the underlying commodity in advance of the date on which the commodity must be delivered, subsequent changes in the price of the underlying asset will inure to the benefit of one party and to the detriment of the other. If the price rises above the futures price, the seller is obligated to deliver the commodity at the lower agreed upon price. The buyer may then resell the received product at the higher market price to realize a profit. The seller in effect loses the difference between the futures contract price and the market price on the date the goods are delivered. Conversely if the price of the underlying commodity falls below the futures price, the seller can obtain the commodity at the lower market price for delivery to the buyer while retaining the higher futures price. In this case the seller realizes a profit in the amount of the difference between the current market price on the delivery date and the futures contract price. The buyer sees an equivalent loss.

Like options contracts, futures contracts may be settled in cash. Rather than actually delivering the underlying asset, cash settlement merely requires payment of the difference between the market price of the underlying commodity or asset on the delivery date and the futures contract price. The difference between the market price and the futures price is to be paid by the short investor to the long investor, or by the long investor to the short investor, depending on which direction the market price has moved. If the prevailing market price is higher than the contract price, the short investor must pay the difference to the long investor. If the market price has fallen, the long investor must pay the difference to the short investor.

Again, like options, cash settlement allows futures contracts to be written against more abstract underlying “assets” or “commodities,” such as market indicators, stock indices, interest rates, futures contracts and other derivatives. For example, an investor may take a long position in a market index futures contract. In this case, the long investor “buys” the index at a specified futures price (i.e. a future value of the index on the “delivery” date). The index based futures contract is cash settled. One party to the contract pays the difference between the futures price and the actual value of the index (often multiplied by a specified multiplier) to the other investor depending on which direction the market has moved. If the value of the index has moved above the futures price, or futures value, the short investor pays the difference the long investor. If the value of the index has moved below the futures price, or futures value the long investor pays the difference to the short investor.

Cash settlement provides great flexibility regarding the types of underlying assets that derivative investment instruments may be built around. Essentially any variable whose value is subject to change over time, may serve as the underlying asset for a derivative investment instrument. While standard derivatives may be based on many different underlying assets, there currently exist no derivative investment instruments that capture changes in the credit ratings of various organizations.

### SUMMARY

The present invention relates to systems and methods for creating and trading credit rating derivative investment instruments. A credit rating derivative investment instrument is an instrument which derives its value based on the credit rating of an entity such as a corporation, municipal government, national government, or supranational organization. The risk categories of an independent credit rating services' rating scheme are mapped to individual monetary values. When an entity is rated by the credit rating service, the rating service assigns a risk level which identifies the perceived credit worthiness of the rated entity. The applicable rating may change over time according to the financial health of the rated entity. As the rated entity's credit rating rises and falls, so do the values to which the various ratings are mapped. According to the invention, credit rating derivative investment instruments such as credit rating options and credit rating futures contracts may be created which are based on the mapped values associated with an entity's credit rating.

A method of creating and trading credit rating derivative investment instruments according to one aspect of the invention includes identifying a credit rating service that rates various entities and organization using a credit rating scheme that includes a plurality of risk categories. The credit rating service rates an entity's credit worthiness by associating a risk category with the entity that accurately reflects the credit rating services assessment of the rated entities credit worthiness. The various risk categories are mapped to unique monetary values, such that if the risk category associated with a rated entity is changed, i.e. upgraded or downgraded, the mapped value will likewise change accordingly. Next an entity which is rated by credit rating service is identified. Derivative investment instruments such as call and put options and futures contracts may be created based on the monetary values to which the rated entity's credit rating is mapped. The value of the derivative investment instrument is determined at least in part by the monetary value to which the current risk category associated with the rated entity is mapped.

According to another aspect of the invention, a system for creating and trading credit rating derivative investment instruments is provided. The system includes a credit rating derivative investment instrument definition module for defining a credit rating derivative investment instrument. A pricing data accumulation and dissemination module is provided for receiving price data which are based on executed credit rating derivative investment instrument trades. The pricing data accumulation and dissemination module also disseminates the pricing data to investors, and data vendors. A credit rating monitoring module monitors the credit rating of the entity on which the credit rating derivative investment is based. Finally, a settlement calculation module is provided for calculating a settlement amount based at least in part on a monetary value to which the current credit rating of the entity is mapped.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the appended claims.

### BRIEF DESCRIPTION OF THE DRAWINGS

FIG. 1 is a table showing the risk categories of a credit rating system mapped to corresponding monetary values.

FIG. 2 is flow chart showing a method of creating and trading credit rating derivative investment instruments.

FIG. 3 is a block diagram of an electronic trading facility for trading credit rating derivative investment instruments.

FIG. 4 is a block diagram of backend systems supporting the trading of credit rating derivative contracts.

### DETAILED DESCRIPTION OF THE PRESENTLY PREFERRED EMBODIMENTS

The present invention provides derivative investment instruments that are based on the movements of an organization's credit rating. In the same way that traditional options and futures contracts derive their value based on changes in the market price or value of an underlying asset, the derivative investments of the present invention derive their value based on changes in an entity's credit rating. The credit rating derivatives of the present invention may encompass options and futures-type instruments and may be traded on an exchange, in either an open outcry format or electronically.

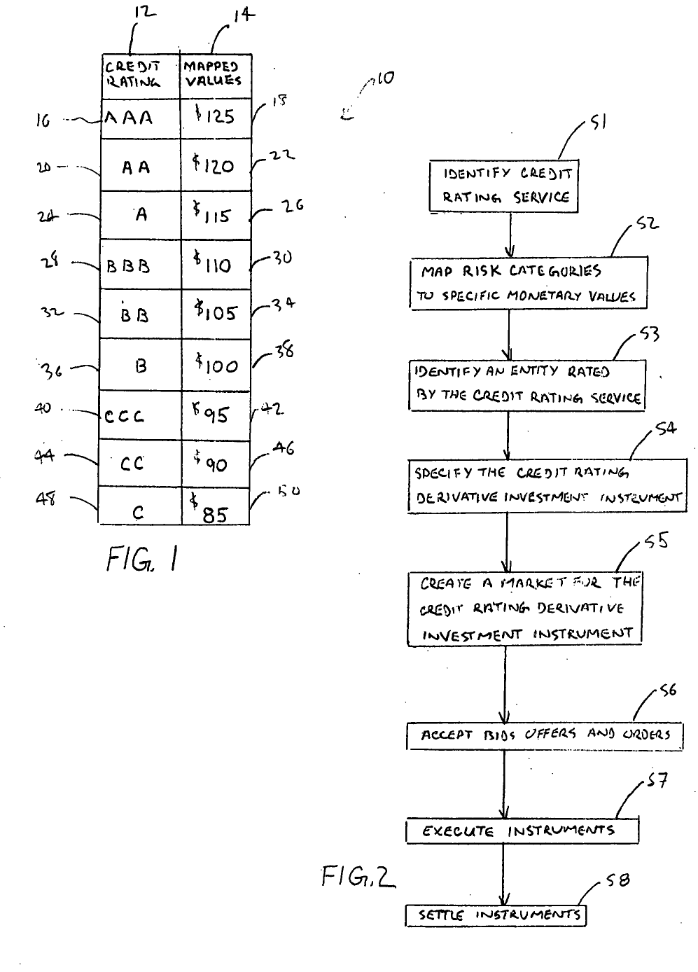

According to one embodiment, the various credit rating levels of a credit rating service's rating scheme are mapped to specific monetary values. For example, FIG. 1 shows a table 10 mapping the primary risk categories of S&P's credit rating scheme to various dollar amounts. Table 10 includes two columns. The first column 12 contains the letter ratings defining the different risk categories. As described in the background of the invention, the S&P credit rating scheme includes nine primary risk categories AAA, AA, A, BBB, BB, B, CCC, CC, and C. (The number of categories is actually expanded by the addition of the (+) and (−) modifiers to rating categories AA-CCC but, for ease of illustration, the modifiers have been omitted.) The second column 14 contains the dollar values to which the primary risk categories of column 12 are mapped. In the present example, the highest rating AAA is mapped to $125. AA is mapped to $120 and so forth in $5 decrements until the lowest rating C is mapped to $85.

The mapping of risk categories to monetary values is substantially arbitrary. A different credit rating scheme may be employed having more or less risk categories. For example, Moody's or Fitch's rating systems may have been employed. The modifiers (1), (2), (3) or (+) and (−) may be included to increase the number of risk categories, (increasing the number of mapped values as a result). Or a different rating scheme altogether may be selected. A different currency may be employed as the monetary unit for column 14. Different mapped values may be employed, with different increments there between. The only restriction regarding the selection of the mapped values is that the mapped values progress in a logical manner that corresponds with the progression of their associated risk categories.

The monetary values to which the various credit rating risk categories are mapped have many similarities with corporate share prices commodity prices, and market indexes. Keep in mind that only a single risk category (AAA, AA, A, etc.) 16, will be applied to a rated entity (corporation, municipal government, national government, supranational, etc.) at any given time. However, the credit rating risk category applied to describe the entity's credit worthiness may in fact change over time depending on the rated entity's perceived ability to repay its debts. As the credit rating risk category changes, the mapped monetary value changes with it. For example, for an entity having a B credit rating the associated mapped value is $100. If the entity's credit rating is upgraded to BB, the corresponding mapped value is $105. Similarly, if the entity's rating is downgraded to CCC, the corresponding mapped value is $95. Thus, just like a company's share price, which moves up and down with the company's performance, or just as a market index goes up and down based on the performance of a group of stocks, or just as commodity prices move up and down based on supply and demand, so the mapped values associated with an entity's credit rating will rise and fall with chances in the entity's perceived ability to pay its debts. And just as derivative investment instruments may be written based on corporate share prices, market indexes or commodity prices, so to may derivative investment instruments be written based on the monetary values associated with an entity's credit rating.

A credit rating call option may be created as follows. A long investor may choose to buy the right to “purchase” an entity's credit rating at a specified category or strike value, such as BB or $105, the value to which a BB credit rating is mapped. If the entity's credit rating improves before expiration of the option, for example if the entity's credit rating is upgraded to AA, the call option will be in-the-money. This situation corresponds exactly with a standard in-the-money call option based on a company's share price. When a corporate share price rises above the strike price, a call option is in-the-money. The long investor is entitled to collect the difference between the actual share price and the strike price. In the case of the credit rating call option, the strike price is the credit rating category BB, or the corresponding mapped value $105. When the entity's credit rating is upgraded to AA, the current credit rating is several levels above the BB strike rating. Similarly the value mapped to the current credit rating, $120, is $15 above the BB strike price. Or we can say that the value or price to $105 corresponds to the value to which the BB strike rating is mapped. The long investor bought the right to “purchase” the entity's credit rating at BB or $105, since current rating is AA, which maps to $120, the long investor is entitled to collect the difference between the present value $120 and the strike value $105 or a total of $15. Since the credit rating option is to be settled in cash, the short investor who sold the option is obligated to pay the $15 to the long investor.

A credit rating put option operates in much the same way, only in reverse. A long investor may choose to buy the right to “sell” an entity's credit rating at a specified category or strike value such A or $115, the value to which an A credit rating is mapped. If the entity's credit rating is downgraded to a level below A before the expiration of the option, for example if the entity's credit rating is downgraded to CC, the credit rating put option will be in-the-money. This situation corresponds exactly with an in-the-money put option based on a company's share price. When a corporate share price falls below the strike price, the put option is in-the-money. The short investor who sold the option must pay the difference between the current share price and the strike price to the long investor. In the case of the present credit rating put option, the strike rating is AA. This maps to a strike value or strike price, of $120. When the entity's credit rating is downgraded CC, the credit rating is several levels below the A strike rating. Similarly, value to which the CC rating is mapped, $90, is lower than the $115 value to which the strike value is mapped. In this case, the long investor bought the right to “sell” the credit rating at A or $115. Since the current rating is CC which maps to $90, the long investor is entitled to collect the difference. Since the credit rating option is to be cash settled, the short investor is obligated to pay the $25 difference between A strike rating ($120) and the current CC rating ($90).

Next we will consider a credit rating futures contract. Again referring to the table 10 in FIG. 1, the values to which the various credit rating risk categories are mapped may function as the commodity or asset price for a credit rating futures contract. A long investor may anticipate that a particular entity's credit rating will be at or above a certain level at some time in the future. A short investor may hold the opposite view that the entity's credit rating will in fact be below the level anticipated by the long investor. For example, assume that the long investor believes the entity's credit rating will be at A or above BB rating and the short investor believes it will be below that level on a specified date in the future.

The long and short investors may then enter into a futures agreement wherein the long investor agrees to “buy” the entity's credit rating on the specified date for the amount corresponding to the BB rating, or $105. If, on the specified date, the entity's credit rating has been upgraded to a level above the BB futures rating, the short investor will be obligated to pay the difference between the value to which the actual credit rating is mapped, and the $105 value to which the BB futures rating is mapped. For example, if the entity's credit rating had been upgraded and stands at AAA on the specified date, the short investor would be obligated to pay the long investor the difference between $125, the value to which an AAA rating is mapped, and $105, the value to which the BB futures rating is mapped, and $105, the value to which the BB futures rating is mapped, or a total of $20. Conversely, if on the specified date the entity's credit rating has been downgraded to a level below the futures rating, the long investor will be obligated to pay the difference between the value to which the actual credit rating is mapped and the $105 value to which the BB futures rating is mapped. For example, if the entity's credit rating had been downgraded and stands at C rating on the expiration date, the long investor would be obligated to pay to the short investor the difference between $85, the value to which a C credit rating is mapped, and $105, the value to which the BB futures credit rating is mapped, or a total of $20.

FIG. 2 shows a flow chart of a method of creating and trading credit rating derivative investment instruments. According to an embodiment of the invention, step S1 is to identify a credit rating service whose rating of an entity or organization will serve as the basis of a derivative investment instrument. Step S2 is to map the various risk categories of the rating services rating scheme to specific monetary values. Step S3 is to identify an entity which is rated by the credit rating service identified in Step S1, and whose credit rating is to serve as the basis for the credit rating derivative instruments. Step S4 is to specify a credit rating derivative instrument based on the credit rating of the entity identified in Step S3 and the monetary values to which the credit risk categories of the credit rating service's rating scheme are mapped to. Step S5 is to create a market for the credit rating derivative instrument. Step S6 is to accept bids, offers and purchase orders for both long and short positions credit rating derivative instruments which are to be created according to the credit rating derivative investment instrument specified in step S4. Step S7 is to execute credit rating derivative investment instrument by matching corresponding orders for long and short positions. And, finally, step S8 is to settle positions in the executed credit rating derivative investment instruments.

It is intended that credit rating derivative investment instruments according to the present invention will be traded on an exchange. The exchange may be a traditional open outcry exchange, or it may be an electronic trading platform such as the Chicago Board Options Exchange (CBOE) Futures Network (CFN). Employing the method outlined in FIG. 2, the exchange may from time to time identify entities whose credit ratings may be of interest to investors. The exchange may decide to specify credit rating derivative investment instruments such as credit rating option contracts or credit rating futures contracts based on the entities credit rating, as determined by an independent credit rating service.

Creating a market for the credit rating derivative investment instruments may be accomplished by listing one or more specified contracts on an exchange or trading platform. Listing a contract includes disseminating information about the contract to potential investors and providing a mechanism whereby investors may make bids and offers and place orders for the contracts. Credit rating derivative investment instruments may traded on the CBOEdirect® electronic trading platform For example, CBOEdirect is a trading facility which disseminates information regarding contracts traded on the platform, and allows brokers and dealers to place orders for customers who enter bids and make offers to buy and sell positions in such contracts.

Essentially, once a contract is defined and listed, the CBOEdirect electronic trading platform, in conjunction with other backend systems of the exchange, is responsible for all of the remaining steps of the method shown in FIG. 2. CBOE direct accepts bids and offers from investors or brokers (Step S6), and executes marketable orders by matching buyers to sellers (Step S7.) And settles the contracts (Step S8).

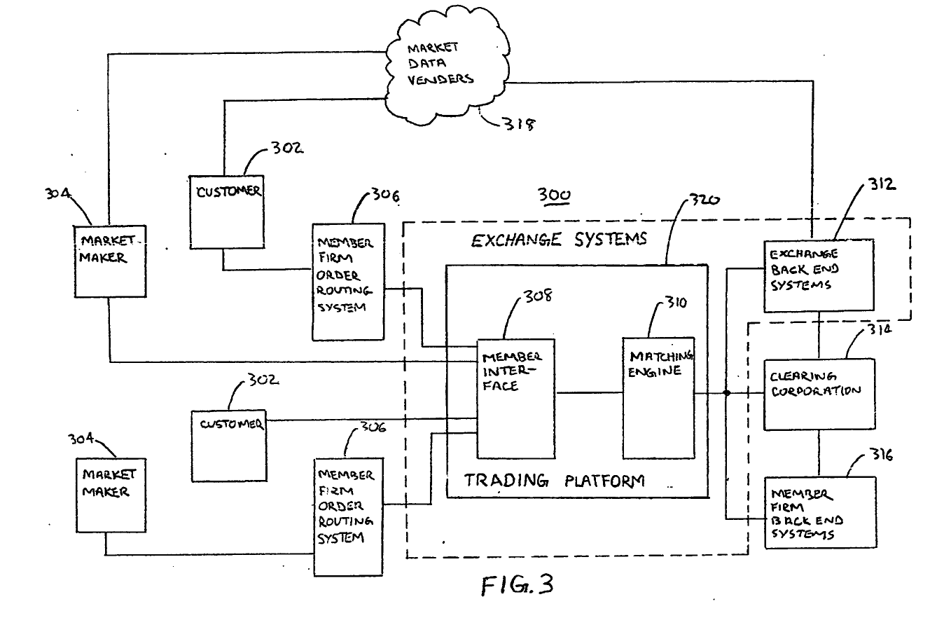

FIG. 3 shows an electronic trading system 300 which may be used for listing and trading credit rating derivative investment instruments. The system 300 includes components operated by an exchange, as well as components operated by others who access the exchange to execute trades. The components shown within the dashed lines are those operated by the exchange. Components outside the dashed lines are operated by others, but nonetheless are necessary for the operation of a functioning Exchange. The exchange components of the trading system 300 include an electronic trading platform 320, a member interface 308, a matching engine 310, and backend systems 312. Backend systems not operated by the exchange but which are integral to processing trades and settling contracts are the Clearing Corporation's systems 314, and Member Firms' backend systems 316.

Market Makers may access the trading platform 320 directly through personal input devices 304 which communicate with the member interface 308. Market makers may quote prices for digital futures contracts. Non-member Customers 302, however, must access the Exchange through a Member Firm. Customer orders are routed through Member Firm routing systems 306. The Member Firms' routing systems 306 forward the orders to the Exchange via the member interface 308. The member interface 308 manages all communications between the Member Firm routing systems 306 and Market Makers' personal input devices 304; determines whether orders may be processed by the trading platform; and determines the appropriate matching engine for processing the orders. Although only a single matching engine 310 is shown in FIG. 3, the trading platform 320 may include multiple matching engines. Different exchange traded products may be allocated to different matching engines for efficient execution of trades. When the member interface 302 receives an order from a Member Firm routing system 306, the member interface 308 determines the proper matching engine 310 for processing the order and forwards the order to the appropriate matching engine. The matching engine 310 executes trades by pairing corresponding marketable buy/sell orders. Non-marketable orders are placed in an electronic order book.

Once orders are executed, the matching engine 310 sends details of the executed transactions to the exchange backend systems 312, to the Clearing Corporation systems 314, and to the Member Firms' backend systems 316. The matching engine also updates the order book to reflect changes in the market based on the executed transactions. Orders that previously were not marketable may become marketable due to changes in the market. If so, the matching engine 310 executes these orders as well.

The exchange backend systems 312 perform a number of different functions. For example, contract definition and listing data originate with the exchange backend systems 312. Pricing information for credit rating derivative investment instruments is disseminated from the exchange backend systems to market data vendors 318. Customers 302, market makers 304, and others may access the market data regarding derivative investment instruments via, for example, proprietary networks, on-line services, and the like. The exchange backend systems also monitor the credit ratings of the entities on which the derivative investment instruments are based. At settlement, the backend systems 312 determine the appropriate settlement amounts and supply final settlement data to the Clearing Corporation. The Clearing Corporation acts as the exchange's bank and performs a final mark-to-market on Member Firm margin accounts based on the positions taken by the Member Firms' customers. The final mark-to-market reflects the final settlement amounts for credit rating derivate investment instruments, and the Clearing Corporation debits/credits Member Firms' accounts accordingly. These data are also forwarded to the Member Firms' systems 316 so that they may update their customer accounts as well.

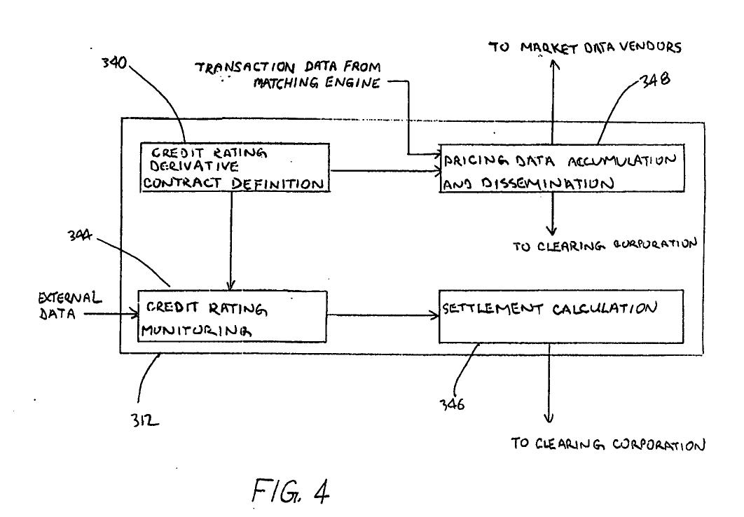

FIG. 4 shows the exchange backend systems 312 needed for trading credit rating derivative investment instruments in more detail. A credit rating derivative investment instrument definition model definition module 340 stores all relevant data concerning the credit rating derivative investment instrument, to be traded on the trading platform 320, including the contract symbol, the identity of the rated entity, the rating service, mapping of the credit risk categories to the monetary values, strike prices futures prices and the like. A pricing data accumulation and dissemination module 348 receives contract information from the credit rating derivative investment instrument definition module 340 and transaction data from the matching engine 310. The pricing data accumulation and dissemination module 348 provides the market data regarding open bids and offers and recent transactions to the market data vendors 318. The pricing data accumulation and dissemination module 348 also forwards transaction data to the Clearing Corporation so that the Clearing Corporation may mark-to-market the accounts of Member Firms at the close of each trading day, taking into account current market prices for the credit rating derivative investment instruments. Finally, a settlement calculation module 346 receives input from the credit rating service when a credit rating derivative investment instrument is settled, the settlement date the settlement calculation module 346 calculates the settlement amount based on the rated entity's present rating and the monetary value to which it is mapped. The settlement calculation module 346 forwards the settlement amount to the Clearing Corporation which performs a final mark-to-market on the Member Firms' accounts to settle the credit rating derivative investment instrument.

According to another aspect of the present invention, chooser options may be created based on credit rating options. A chooser option is an option wherein the purchaser of the option buys a call or a put option at some time in the future. The call and the put option will typically share the same expiration date and the same strike price (value), although, split chooser options may be crafted wherein the call and the put options have different expirations and/or different strikes.

Chooser options are advantageous in situations in which investors believe that the price of the underlying asset is for a significant move, but the redirection of the move is in doubt. For example, some event, such as the approval (disapproval) of a new product, a new earnings report, or the like, may be anticipated such that positive news is likely cause the share price to rise, and negative news will cause the share price to fall. The ability to choose whether an option will be a put or a call having knowledge of the outcome of such an event is a distinct advantage to an investor.

The purchase of a chooser option is akin to purchasing both a put and a call option on the same underlying asset. Typically, the chooser option is priced accordingly. In the present case, purchasing a credit rating chooser option amounts to buying both a put and a call option based on the credit rating of a rated entity. Chooser options may be traded on an exchange just like other credit rating derivative investment instruments. The only accommodations necessary for adapting an exchange for trading chooser options is that a final date for making the choice between a call option and a put option must be established and maintained. Also, post trade processing on the exchange's and systems must be updated to implement and track the choice of the call or a put once the choice has been made. One option for processing the chosen leg of a chooser option is to convert the chooser option into a standard option contract according to the standard series for the same underlying asset and having the same strike price as the chosen leg of the chooser option.

The method of creating and trading credit rating derivative investment instruments and the system for trading such instruments provides investors with a vehicle for taking position relative to changes in various organizations' credit ratings. The ability to take positions regarding organization's credit ratings provides investors with additional tools for managing and diversifying investment risks.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of creating and trading derivative investment instruments based on an entity's credit rating, the method comprising:
identifying a credit rating service having a credit rating scheme that includes a plurality of risk categories, wherein the credit rating service rates an entity's credit worthiness by associating an appropriate one of said plurality of risk categories with the entity;
mapping the risk categories to unique monetary values;
identifying an entity which is rated by the credit rating service; and
creating a credit rating derivative investment instrument whose value is determined at least in part by the monetary value to which the risk category associated with the rated entity is mapped.

2. The method of claim 1 wherein the credit rating derivative investment instrument comprises a credit rating futures contracts.

3. The method of claim 1 wherein the credit rating investment instrument comprises a credit rating call option.

4. The method of claim 1 wherein the credit rating investment instrument comprises a credit rating put option.

5. The method of claim 1 wherein the credit rating service comprises one of:
Moody's Investor Services; Standard and Poor's; or Fitch's ratings.

6. The method of claim 1 further comprising listing the credit rating derivative investment instrument on an exchange.

7. The method of claim 6 further comprising accepting orders from investors to take positions in credit rating derivative investment instruments, and executing orders by matching corresponding orders to take opposite sides in credit rating derivative investment instruments.

8. A method of creating investment instruments comprising:
identifying a rating scheme having a plurality of different levels, each level corresponding to a state of a variable attribute of an entity;
associating each level with a value;
evaluating the state of the variable attribute of the entity over time to determine the level of the rating scheme that corresponds to a current state of the variable attribute in order to rate the entity; and
creating an investment instrument whose value is derived from the entity's rating and the value associated with the corresponding level of the rating scheme.

9. The method of claim 8 wherein the investment instrument comprises a credit rating futures contracts.

10. The method of claim 8 wherein the investment instrument comprises a credit rating call option.

11. The method of claim 8 wherein the investment instrument comprises a credit rating put option.

12. The method of claim 8 wherein the rating scheme comprises a credit rating scheme employed by a credit rating service.

13. The method of claim 12 wherein the credit rating service comprises one of: Moody's Investor Services; Standard and Poor's; or Fitch's ratings.

14. The method of claim 8 wherein evaluating a variable attribute of an entity comprises evaluating the entity's credit worthiness.

15. The method of claim 14 wherein the entity comprises one of: a business; a municipal government, a national government; or a supranational organization.

16. The method of claim 8 wherein evaluating a variable attribute of an entity comprises evaluating a level of risk related to a debt issue.

17. The method of claim 1 further comprising listing the investment instrument on an exchange.

18. The method of claim 17 further comprising accepting orders from investors to take positions in credit rating derivative investment instruments, and executing orders by matching corresponding orders to take opposite sides in credit rating derivative investment instruments.

19. A system for creating and trading credit rating derivative investment instruments on an exchange comprising:
a credit rating derivative definition module for defining a credit rating derivative investment instrument;
a pricing data accumulation and dissemination module for receiving price data based on executed trades of said credit rating derivative investment instruments, and disseminating said pricing data to investors;
a credit rating monitoring module for monitoring the credit rating of an entity; and
a settlement calculation module for calculating a settlement amount based at least in part on a monetary value to which the current credit rating of the entity is mapped.
